(19) United States
(12) Patent Application Publication
(10) Pub. No.: US 2005/0001160 A1
(43) Pub. Date: Jan. 6, 2005

(54) Determination of sample purity through mass spectroscopy analysis

(76) Inventor: Michael Wall, Vallejo, CA (US)

Correspondence Address: Lucian Wayne Beavers;Waddey & Patterson, Bank of America Plaza, Suite 2020, 414 Union Street, Nashville, TN, 37219, US

(21) Appl. No.: 10/896,400

(22) Filed: Jul. 21, 2004

Related U.S. Application Data
(63) Continuation of application No. 10/093,285, filed on Mar. 5, 2002.

(51) Int. Cl. H01J 49/00

(52) U.S. Cl. 250/281; 250/282

(57) ABSTRACT

The field of the present invention is in the area of mass spectroscopy and purity analysis. Specifically the invention is related to determining the purity of sample of materials. The invention also relates to identifying an unknown sample. The present invention also provides a web-based system for scientists to interact with a computer to implement the method. Further the scientist is able to upload and download information to and from the method to and from a database or laboratory information management system. The present invention also provides for an efficient hardware architecture to implement the method.

### FIELD OF INVENTION

The field of the present invention is in the area of mass spectroscopy and purity analysis. Specifically the invention is related to determining the purity of samples of materials. The invention also relates to identification of an unknown sample of materials and the creation of their reaction trees.

### BACKGROUND

1. Mass Spectroscopy

Mass spectrometry is concerned with the separation of matter according to atomic and molecular mass. It is most often used in the analysis of organic compounds of molecular mass up to as high as 200,000 Daltons, and until recent years was largely restricted to relatively volatile compounds. Continuous development and improvement of instrumentation and techniques have made mass spectrometry the most versatile, sensitive and widely used analytical method available today.

2. Rooted Trees

A rooted tree is a tree in which one of the vertices is distinguished from the others. The distinguished vertex is called the root of the tree. Consider a node x in a rooted tree T with root r. Any node y on the unique path from r to x is called an ancestor of x. If y is an ancestor of x, then x is a descendent of y. If the last edge on the path from the root r of a tree T to a node x is (y,x), then y is the parent of x, and x is a child of y. The root is the only node in T with no parent. If two nodes have the same parent, they are siblings. A node with no children is an external node or leaf. A non-leaf node is an internal node.

3. Enzymatic Digestion

Enzymatic digestion of a protein (or any other substance) is usually described as Michaelis-Menton reaction with E as the enzyme, S as the Substrate or Protein, and P as the products, e.g.:
E+S< - - >[ES]< - - >E+P
The first step, formation of the enzyme substrate complex [ES] is usually assumed to occur much faster than the formation of products E and P. (Detailed consideration of the actual reaction kinetics is not necessary to the method described herein.) In the lab, enzyme is introduced to protein for a specified amount of time. After the specified digestion time, the reaction is then stopped (quenched). In the case of trypsin, the reaction is stopped (quenched) with the introduction of acid. Also, inhibitors of enzymes may be used to slow down an enzymatic digestion.
4. Enzymatic Digestions as Trees

An enzymatic digestion may also theoretically be thought of in the form of a rooted tree. Consider the hypothetical protein ABC with cleavage sites between AB and between BC. Assuming enzymatic cleavage occurs only at one site at a time (i.e. it is rare that simultaneous multi-site cleavage occurs), the reaction may be described as in FIG. 1. In reaction tree 101, first A is cleaved leaving BC. Then finally B and C are cleaved from each other leaving A, B, and C. On the other hand in reaction tree 102, first C is cleaved from AB and then A and B are cleaved from each other. This digestion again yields the separate compounds A, and B, and C.

From the above reactions, parent/child relations may be developed. In both sets of reactions, the compound ABC is the root of the tree. In the first set of reactions, A and BC are both the child nodes (children) of ABC. Finally, B and C are the children of BC. Similarly with the second set of reactions described in reaction tree 102, AB and C are the children to the parent ABC. Further, A and B are the children of AB.

### OBJECTS AND SUMMARY OF PRESENT INVENTION

It may be an aspect of the present invention to provide a method for determining the purity of a sample. This method may comprise performing mass spectroscopy on a sample to create a mass spectrum and then determining the reaction tree of the products of the sample from the mass spectrum. Finally the method may determine if the products of the sample are from common ancestors.

Another aspect of the present invention may be an apparatus for determining the purity of a sample. The apparatus may comprise means for obtaining the mass spectrum of a sample, means for grouping peaks of the mass spectrum into categories, and means for determining the number of categories in the sample.

It may further be an object of the present invention to provide for a computer system having a graphical interface including a display device and a selection device, a method of displaying information on the display device in a menu form and accepting menu selection input from a user. The computer system may retrieve a set of menu entries for the menu, each of the menu entries representing a method to perform upon mass spectra of samples. The computer system may then display the set of menu entries on a display device. The computer system may then display a set of parameters on a display device. The computer system may then provide the user an opportunity to modify the set of parameters. Finally, after receiving an indication from the user, the computer system may perform a method on the mass spectra of samples to determine the purity of the samples based on the set of parameters and said set of menu entries. The computer system also may determine the product trees of the samples.

Another aspect of the present invention may be a set of application program interfaces embodied on a computer-readable medium for execution on a computer in conjunction with an application program that determines the purity of samples. The interfaces may include a first interface that receives functions for a method analyzing mass spectra and a second interface that receives parameters for the analysis. The interfaces may further comprise a third interface that receives mass spectra of the samples. Finally the set of application programs may return the purity of the samples.

Another aspect of the present invention may be a method of deconvoluting samples. The method may comprise obtaining the mass spectrum of a sample and creating reactions trees of the products from the sample's mass spectrum. The method may then determine if the reaction trees are separate.

### BRIEF DESCRIPTION OF DRAWINGS

FIG. 1 may be an exemplary set of reaction trees.

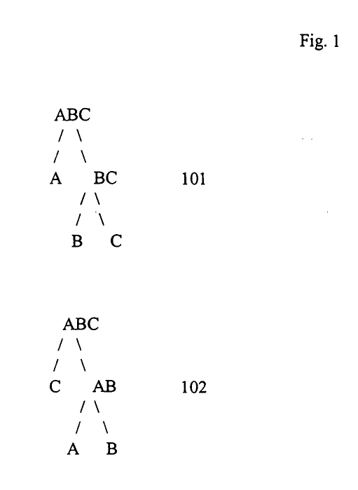

FIG. 2 may demonstrate an exemplary graph based on a theoretical trypsin digest to determine values of ε.

FIG. 3 may be an exemplary mass spectrum of a sample.

FIG. 4 may be an exemplary reaction tree derived from the exemplary mass spectrum of FIG. 3.

FIG. 5 may be an exemplary mass spectrum of a sample.

FIG. 6 may be a set of exemplary reactions trees derived from the exemplary mass spectrum of FIG. 5.

FIG. 7 may be an exemplary flow chart of a method of the present invention.

FIG. 8 may be an exemplary display of a graphical interface usable with the present invention.

FIG. 9 may be an exemplary architecture of a computer-based system usable with the present invention

### DETAILED DESCRIPTION OF VARIOUS EMBODIMENTS

The present invention can be embodied as a software application resident with, in, or on any of the following: a database, a Web-server, a separate programmable device that communicates with a Web-sever through a communication means, a software device, a tangible computer-usable medium, or otherwise. Embodiments comprising software applications resident on a programmable device are preferred. Alternatively, the present invention can be embodied as hardware with specific circuits, although these circuits are not now preferred because of their cost, lack of flexibility, and expense of modification.

The present invention may be a computer program used in conjunction with the mass spectroscopy results of a sample.

The present invention may provide several ways to determine the purity of a sample. One method may be to execute a method of the present invention on a sample's mass spectrum. A method of determining the purity of a sample may be executed as described below:
1. Determine a threshold for the mass spectrum that indicates a positive result for each specific mass in the spectrum. A threshold may be selected to be any peak that is higher than one standard deviation above the mean peak.
2. For each mass with a peak above the minimum threshold determine for all peaks i and j if there a is peak corresponding to i+j. If such a peak is found, then the peak located at i+j is the parent of peaks i and j. Thus the peak i+j may be inserted into a tree as the parent node to peak i and j.
3. Continue step two until all peaks pairs i and j have been searched.
   The method to determine the product tree of the sample may also provide a tolerance to determine if the peak near i+j may be used as the parent of peaks i and j. The peak may be considered the parent of peaks i and j if the following equation holds true: |β+α−δ−γ|<ε. In this equation β is the mass of peak i, α is the mass of peak j, δ is the mass of peak i+j, γ is the loss of molecular mass due to chemical modifications (such as the loss of H₂O from enzymatic cleavage or uptake of acrylamide monomers), and ε is the error tolerance allowed by the user. A typical error tolerance may be 1.0 e-5 AMU but may be reliably set between 1.0 e-3 AMU and 1.0 e-7 AMU. The determination of γ is well known in the art of mass spectroscopy and chemistry.

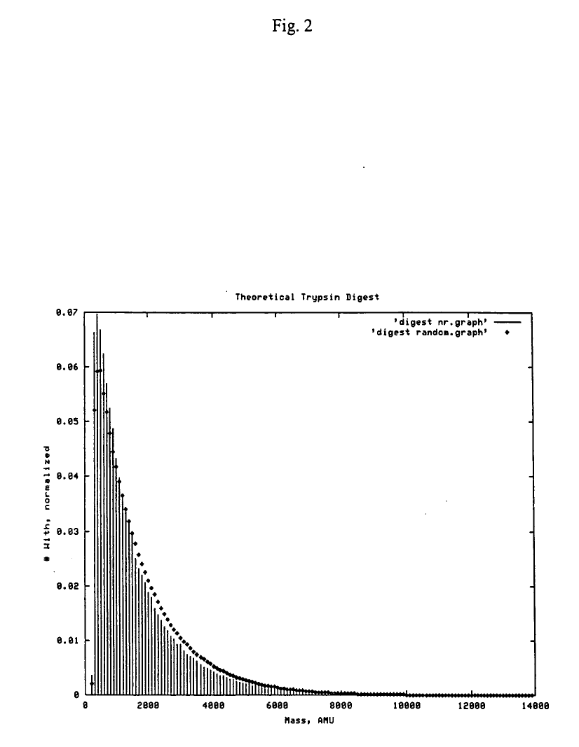

The window being set at ε may provide a high reliability that a peak that contains the mass of i+j−γ±ε is the peak that creates the products corresponding to the peaks i and j. In order to lower the chance that the sum of the children is the actual parent rather than coincidence, the value of ε can be chosen from the actual molecular weight distribution resultant from a theoretical digest. The theoretical digest may be either from a public protein database such as NR, or a theoretical digest of randomly generated peptide fragments. One may select a more conservative value of ε from a measure of the theoretical density of states which is Σ(sum x=a to x=b) 22\hat{ }x/(x−2)!/129x, where the lower limit “a” and the upper limit “b” are the minimum and maximum chain lenghts that fall into the molecular weight window ε. FIG. 2 demonstrates and exemplary graph of ε according to a theoretical trypsin digest.

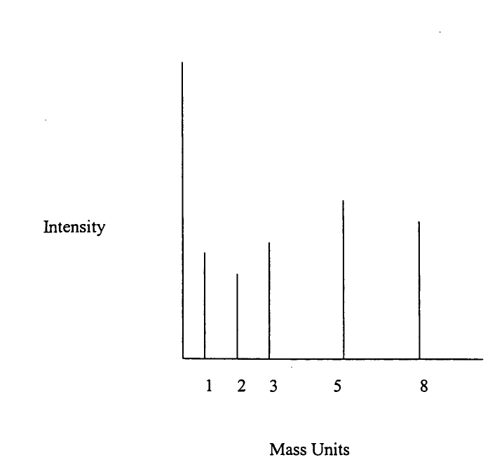

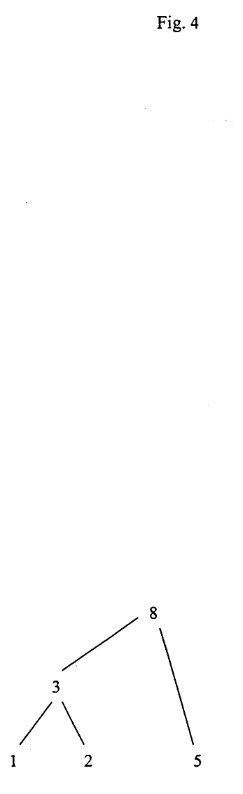

FIG. 3 is an exemplary mass spectrum with peaks at 1, 2, 3, 5, and 8 mass units. The method of the present invention may take these peaks into consideration when creating the product tree for the reaction. The method may start by selecting the first two unmatched nodes 1 and 2. The method may then determine if these nodes sum to within γ+ε of the mass of another node. In this example, 3 is with γ+ε of 1+2. Therefore, the method may select 3 as the parent of 1 and 2 and may create a subtree with 1 and 2 as the children and 3 as the parent node. After this step the method may find that 3, 5, and 8 are the only unpaired nodes remaining. It may the find that 3 and 5 sum to 8 and may therefore determine that 8 is the parent node of 3 and 5. The method may then construct a tree with 8 as the parent node and 5 and 3 as the child nodes. Further from the previous step, 1 and 2 may already be the children of node 3. Therefore the method, when completed on this example may construct a reaction tree such as the exemplary reaction tree of FIG. 4. The method may be completed because 8 is the only unpaired node left to consider or because all the unpaired nodes may not sum to a third unpaired node to within γ+ε. The method may also yield more that one reaction tree if there are more than one unpaired nodes left at the end of the execution of the method. Among other consequences of two reactions trees being derived by the method of the present invention from a single set of mass spectrum may be that there are more than one unique protein in the sample or that the larger portions of the protein in the sample were substantially digested.

The method may be used from products from more than one reaction. In the prior art, a sample would be separated into products to one point, usually completion. When run to completion, the intermediaries are either not observed or weakly observed. These products would then be used to create the mass spectrum. The present invention may use several reactions of a given product to use in mass spectral analysis. One method is to quench separate reactions of the sample at given points. These points may be logarithmic. That is different reactions with the same sample may be quenched at 0.5, 1, 2, 4, 8, and 16 hours. The resulting products may then be mixed together and mass spectroscopy may be applied to the mixture. The resulting mass spectrum may then possess all of the intermediate as well as final products of the digestion of the sample. An example of intermediates would be AB and BC in reaction trees 101 and 102. In this manner, it may be more likely to create the complete reaction tree for the sample and it may be easier to determine if the sample is pure.

Another method of creating a final sample with various amounts of parental products is the use different amounts of catalyst. A logarithmic amount of catalyst may be used to cause the reaction in several separate reactions. The amount of catalyst used in the separate retains may be logarithmic in scale such as 1×, 2×, 4×, 8×, and 16×. After quenching of these reactions a concurrent time, the products of these reactions may be mixed together. Again in this manner, it may be more likely to create the complete product tree for the sample and it may be easier to determine if the sample is pure.

In addition to these methods an enzymatic inhibitor may be added with the catalysts to the reactions. This inhibitor will have the effect of slowing the reaction down. In this manner more intermediates may be found in the earlier reactions to make a more complete tree.

Another embodiment of the methods above can be a method of denaturization with two or more different enzymes for the enzymatic digestions. This may allow several different denaturization pathways to be followed. These pathways may once again be unique for each different protein. However, since more than one enzyme is used for the digestion the protein may be digested by both of them. This may yield more unique intermediaries that may create unique peaks to the protein of interest when the mass spectrum is produced. The number of unique proteins (intermediaries and end products) created may be on the order of the product of the number of unique proteins created by each of the enzymes used alone.

The preceding methods of determining and capturing the intermediates are not meant to be exclusive and are only exemplary. Any method or scheme of creating intermediates currently in use or discovered in the future would be compatible with the present invention.

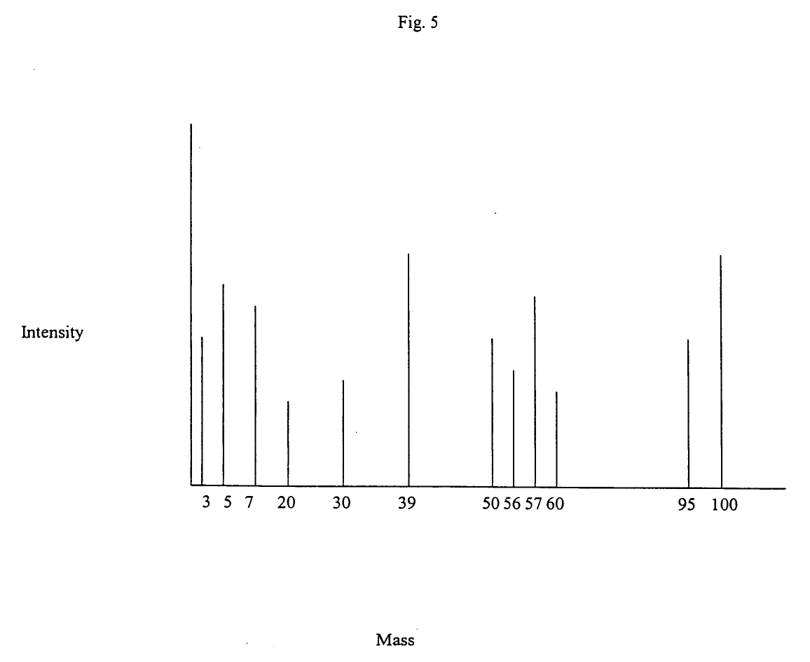

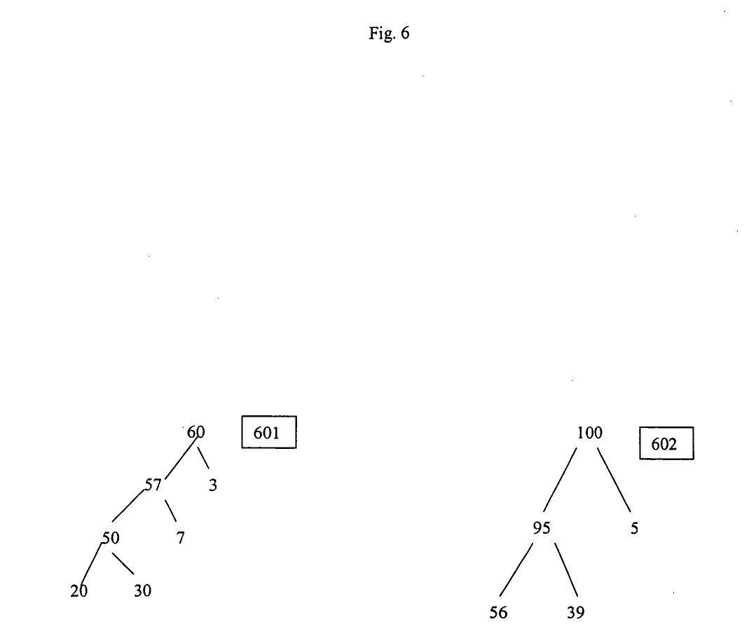

Once determined, the reaction tree can then be used by the researcher to detect impurities, deconvolute a protein mixture, and select peaks for a database search.
(i) Detection of Impurities: Once the mass spectrum of the sample is captured, one may determine the purity of the sample. Pure samples will more likely have small numbers of long reaction trees since there will only be a single substance being denatured in the enzymatic digestion. However, impure samples may have several reaction trees because these samples contain several different specimens that each will provide distinct reaction trees.
(ii) Deconvolution of a Protein Mixture: If a sample contains two or more proteins then it may be possible to separate the two proteins and determine their reaction tree and mass spectrum. This is because is protein in the sample should create its own unique reaction tree. The peaks corresponding to each distinct reaction tree should be those peaks that are specific to each distinct protein.
This method may be understood better with reference to FIGS. 5 and 6. FIG. 5 is an exemplary mass spectrum that may be the result of applying mass spectroscopy to a sample. When the method of the present invention is applied to the mass spectrum of FIG. 5, the reaction trees 601 and 602 (of FIG. 6) may be derived. The two reaction trees 601 and 602 rooted with values of 60 and 100 created from the mass spectrum of a single sample may suggest that the sample contain two separate proteins.
(iii) Select and Discard Peaks for Database Searching: Once one has discovered a particularly large reaction tree, the peaks from this reaction tree may be used to search a database of mass spectra. This has the advantage of removing peaks that are not likely part of the protein of interest (impurities) before the database search is conducted.

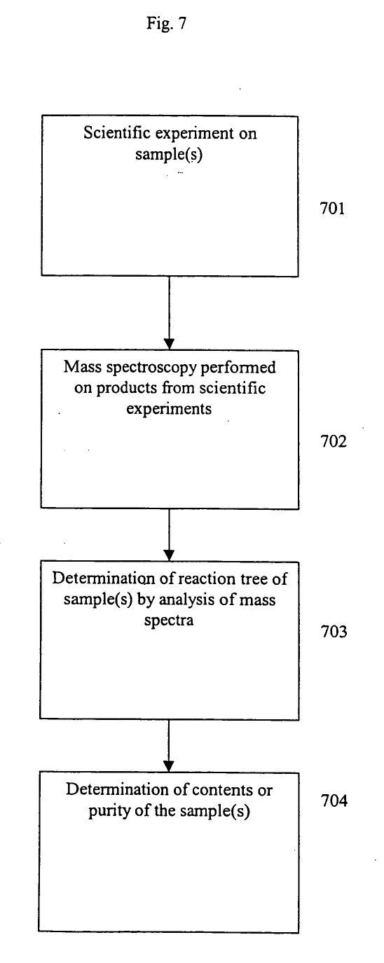

The present invention may be executed in a fashion described in FIG. 7. The present invention may begin with a scientific experiment(s) on a sample 701. The present invention may then performs mass spectroscopy on the products of the reactions of the scientific experiments 702. Then a computer program 703 may be executed to determine the reaction tree of the sample. The computer program may then either determine the contents of the sample and/or the purity of the sample by using the mass spectroscopy and reaction tree data 704. This step may be performed by comparing the mass spectrum and reaction tree of the sample to those already known by the research or located in protein databases.

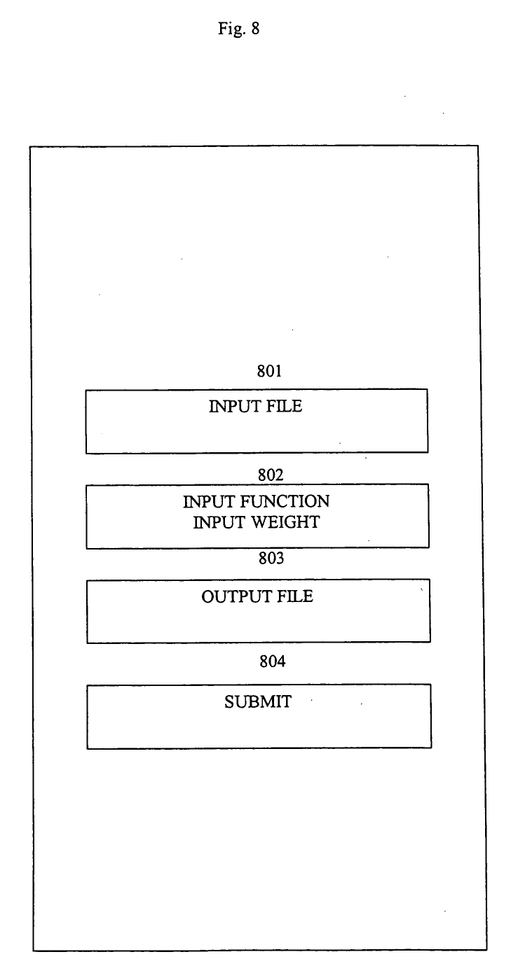

The method may be executed through a web-page and web-server. An exemplary display of such a web-page is FIG. 8. The web-page of FIG. 8 allows a user to input the parameters of the an assembly creator consistent with the present invention. Bar 801 is an exemplary input to the display of a file of mass spectra. It consists of an input bar where a user may type in a file containing mass spectra to be analyzed. The input bar 801 may possess the ability to specify more than one mass spectra file. Bar 802 is an exemplary input bar of the window size (ε) to be used to determine the division of mass spectra peaks into particular peaks. The input bar may be able to specify more than one window size to be used. Input bar 803 allows for input of the destination file for the purity analysis and reaction tree performed and created by the algorithm. Submit button 804 may cause the computer to execute the method with the given parameter. After completing the method the computer may save the results to the file specified in input bar 803. It may also crate a new web page or display that graphically or textually displays the resulting mass spectra and reaction trees. An alternative embodiment may be the use of the present method with a command line interface instead of a GUI interface.

The method may also be incorporated into a laboratory management system. The mass spectroscopy data may be retrieved from a database within a laboratory management system. The results of the purity analysis and reaction tree determination may then be saved back to the database of the laboratory management system. The newly saved data may also contain annotation corresponding to the data that may be entered by the user or automatically generated by the laboratory management system.

The preferred embodiment is for the present invention to be executed by a computer as software stored in a storage medium. The present invention may be executed as an application resident on the hard disk of a PC computer with an Intel Pentium or other microprocessor and displayed with a monitor. The processing device may also be a multiprocessor. The computer may be connected to a mouse or any other equivalent manipulation device. The computer may also be connected to a view screen or any other equivalent display device.

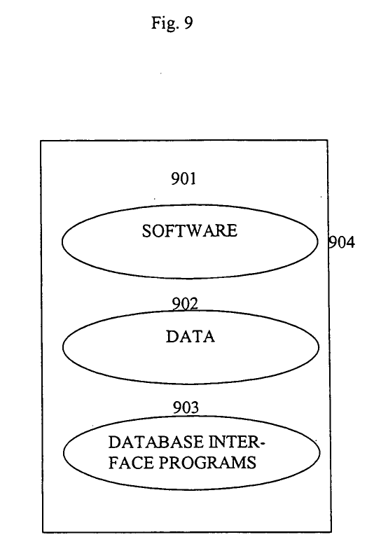

Referring to FIG. 9, part of the process analyzing mass spectra to create reaction trees and to determine purity may be executed by the assembly creation code (software) 901 stored on the program storage device 904. This code may access the mass spectra data 902 and database interface programs 903. Further a GUI within a program or associated with a web-based application may be used to interact with any program.

FIG. 9 shows a program storage device 904 having storage areas 901-903. Information is stored in the storage area in a well-known manner that is readable by a machine, and that tangibly embodies a program of instructions executable by the machine for performing the method of the present invention described herein for creating reaction trees and determining sample purity from mass spectra data. Program storage device 904 could be volatile memory, such as dynamic random access memory or non-volatile memory, such as a magnetically recordable medium device, such as a hard drive or magnetic diskette, or an optically recordable medium device, such as an optical disk. Alternately, other types of storage devices could be used.

The embodiments described herein are merely illustrative of the principles of this invention. Other arrangements and advantages may be devised by one skilled in the art without departing from the spirit or scope of the invention. Accordingly, the invention should be deemed not to be limited to the above detailed description. Various other embodiments and modifications to the embodiments disclosed herein may be made by those skilled in the art without departing from the scope of the following claims.

1. A method for determining the purity of a sample comprising:
(a) performing mass spectroscopy on a sample to create a mass spectrum;
(b) determining the reaction tree of the products of said sample from said mass spectrum; and
(c) determining if said products of said sample are from common ancestors.

2. The method of claim 1 where the reaction tree is determined by examining intermediates.

3. The method of claim 2 where said intermediates are created using enzymes.

4. The method of claim 3 where there is one enzyme used to create said intermediates.

5. The method of claim 3 where two or more enzymes are used to create said intermediates.

6. An apparatus for determining the purity of a sample comprising:
(a) means for obtaining the mass spectrum of a sample;
(b) means for grouping peaks of said mass spectrum into categories; and
(c) means for determining the number of categories in said sample.

7. The apparatus of claim 6 wherein said categories comprise reaction trees.

8. The apparatus of claim 6 wherein said means for obtaining a mass spectrum comprises mass spectroscopy.

9. The apparatus of claim 8 wherein said mass spectroscopy is performed on a sample which has undergone an enzymatic digestion.

10. In a computer system having a graphical interface including a display device and a selection device, a method of displaying information on the display device in a menu form and accepting menu selection input from a user, the method comprising:
retrieving a set of menu entries for the menu, each of the menu entries representing a method to perform upon mass spectra of samples;
displaying the set of menu entries on the display device;
displaying a set of parameters on the display device;
providing the user an opportunity to modify said set of parameters;
receiving an indication of a menu entry selection from the user via the selection device; and
in response to said indication of a menu entry selection, performing a method on said mass spectra of samples to determine purity of said samples based on said set of parameters and said set of menu entries.

11. The computer system of claim 10, wherein said parameters comprise section for the size of ε.

12. The computer system of claim 10, wherein said parameters include the names of files containing different mass spectra to be used to determine the purity of the sample.

13. A set of application program interfaces embodied on a computer-readable medium for execution on a computer in conjunction with an application program that determines the purity of samples, comprising:
a first interface that receives functions for a method analyzing mass spectra;
a second interface that receives parameters for said analysis;
a third interface that receives mass spectra of said samples; and
returns the purity of said samples.

14. The set of application program interfaces of claim 13 wherein said parameters comprise the size of ε.

15. The set of application program interfaces of claim 13 wherein said method of analyzing mass spectra comprises the creation of reaction trees.

16. A method of deconvoluting samples comprising:
(a) obtaining the mass spectrum of a sample;
(b) creating reactions trees of the products from said sample's mass spectrum; and
(c) determining if said reaction trees are separate.
